(19) United States
(12) Patent Application Publication
(10) Pub. No.: US 2014/0339229 A1
(43) Pub. Date: Nov. 20, 2014

(54) Trash Can Adaptor

(71) Applicants: Kent VanHo, Hayward, CA (US); Tina Dao, Hayward, CA (US)

(72) Inventors: Kent VanHo, Hayward, CA (US); Tina DAO, Hayward, CA (US)

(21) Appl. No.: 14/280,608

(22) Filed: May 17, 2014

Related U.S. Application Data
(60) Provisional application No. 61/825,013, filed on May 18, 2013.

(51) Int. Cl. B65F 1/08; B65F 1/14

(52) U.S. Cl. CPC B65F 1/08; B65F 1/1473
USPC 220/23.87

(57) ABSTRACT

The invention provides an inner can which can be easily adapted to the household trash can. The inner can's exterior shape is substantially identical to the inner shape of the trash can. The inner can has two extensible handles which are used for the user to pull the inner can out from the trash can. It has at least one wheel at the bottom and an extensible handle for the user to pull the loaded inner can without carrying it.

### REFERENCE TO RELATED APPLICATIONS

The present application claims priority to the provisional Appl. Ser. No. 61/825,013 filed on May 18, 2013, the entire content of which is hereby incorporated by reference.

### TECHNICAL FIELD OF THE INVENTION

The present invention generally relates to waste containers. More particularly, this invention is related to an inner can adapted to a waste container.

### BACKGROUND OF THE INVENTION

Trash can is a container for temporarily storing refuse and waste. It is also called dustbin, rubbish bin, refuse bin, litter bin, litter receptacle, kitchen bin, garbage can, trash barrel, or garbage bin. Public containers with wheels are termed wheelie bin and mobile garbage bin respectively.

The wheelie bin is a waste container on wheels designed to make it easier for users to transport heavy loads of refuse to the curb or other pick-up point. More recently it has application for transporting stolen goods on bin day in residential suburbs. George Dempster invented the Dempster-Dumpster system in the 1930s for automatically loading the contents of standardized mobile steel containers onto the dustcart. This led to the classic Dempster Dumpmaster waste collection vehicle of the 1950s, but wheelie bins did not become popular until the 1970s. The term dumpster is frequently used as a generic term for a large MGB or the non-mobile variety in the United States. In the US residential wheelie bins are also generically called “Herbie Curbies.” The modern bin is a German invention of the 1970s in a patent held by Schneider, and licensed to other companies outside Germany. The smaller wheelie bins, for domestic or light commercial use, typically hold 32 to 95 gallons, with 63 gallons being the most common. They have a hinged flap lid and two wheels on the bottom on the same side as the lid hinge. There is a bar behind the hinge on the top of the bin which is used to move it, or to hoist it up onto a garbage truck for emptying. The 63 gallons bin is usually considered to have the same capacity as three traditional waste containers.

The design objectives behind the bin were efficient use of space and safety: to provide at least as much space as the older round bins, whilst reducing the risk of injury caused by moving it. This is important for both the householder and the waste collector, who risked injury through lifting the traditional bin or from sharp or possibly contaminated objects in garbage bags. Standardization of dimensions is important because the bins must be lifted by a standard sized hoist on the dustcart. The bins are lifted by the lip at the front which must be designed for maximum stiffness and mechanical strength. The underside of the lip is therefore reinforced by numerous ribs in the case of the thermoplastic bins. Steel bins have a much simpler lip owing to the properties of steel.

A typical trash can used in household kitchen is usually in cylindrical shape and has a cover, as illustrated in FIG. 1. To keep the inside clean, a plastic bag is inserted. When it contains too much trash, the user shall pull out the plastic bag out of the trash can and carry the load out to the wheelie bin outside of the house. The problem is that the plastic bag may be torn by the some sharp waste or thus when the user carries the load, leaking may happen. Leaking would create creates an unhealthy and aesthetically unpleasant atmosphere. Another problem is that the trash load may be too heavy for seniors or younger ones.

The purpose if this invention is to overcome these problems. What is desired is a portable inner can adapted to the existing trash can which allow the user to remove the trash load from the trash can and move the inner can outside of the house easily and conveniently.

### SUMMARY OF THE INVENTION

The present invention discloses and teaches an inner can which can be adapted to the household kitchen trash can.

The exterior shape is designed according to the shape and measurement of trash can's inner side. The inner can's exterior shape is substantially identical to the trash can's inner shape. However, the inner can's exterior measurement is slightly operably smaller than the trash can's inner measurement such that the inner can be placed in and removed from the trash can easily.

The inner can has two extensible handles which are used for the user to pull the inner can out from the trash can. It has at least one wheel at the bottom and an extensible handle for the user to pull the loaded inner can instead of carrying it.

### BRIEF DESCRIPTION OF THE DRAWINGS

FIG. 1 is a schematic diagram illustrating a typical kitchen waste container according to the prior art.

FIG. 2 is a schematic diagram illustrating an inner can for use in coupling with the cylindrical waste container of FIG. 1.

FIG. 3A is a schematic diagram illustrating a typical structure for the extensible handle for the user to pull out and move the loaded inner can.

FIG. 3B is a schematic diagram illustrating a typical structure for the extensible handle for the user to pull the inner can out from the waste container.

FIG. 4 is a schematic diagram illustrating a sectional view of the inner can placed in the waste container.

FIG. 5A is a schematic diagram illustrating the inner can's bottom with one wheel and two feet.

FIG. 5B is a schematic diagram illustrating the inner can's bottom with two wheels and one foot.

FIG. 5C is a schematic diagram illustrating the inner can's bottom with three wheels.

FIG. 5D is a schematic diagram illustrating the inner can's bottom with four wheels.

FIG. 6 is a schematic diagram illustrating a half-cylindrical waste container.

FIG. 7 is a schematic diagram illustrating an inner can for use in coupling with the half-cylindrical waste container of FIG. 6.

FIG. 8A is a schematic diagram illustrating the bottom of the inner can of FIG. 7 which has one wheel and one foot.

FIG. 8B is a schematic diagram illustrating the bottom of the inner can of FIG. 7 which has two wheels and one foot.

FIG. 8C is a schematic diagram illustrating the bottom of the inner can of FIG. 7 which has three wheels.

FIG. 8D is a schematic diagram illustrating the bottom of the inner can of FIG. 7 which has four wheels.

FIG. 9 is a schematic diagram illustrating a cubical waste container.

FIG. 10 is a schematic diagram illustrating an inner can for use in coupling with the cubical waste container of FIG. 9.

FIG. 11A is a schematic diagram illustrating the bottom of the inner can of FIG. 10 which has one wheel and two feet.

FIG. 11B is a schematic diagram illustrating the bottom of the inner can of FIG. 10 which has two wheels and one foot.

FIG. 11C is a schematic diagram illustrating the bottom of the inner can of FIG. 10 which has three wheels.

FIG. 11D is a schematic diagram illustrating the bottom of the inner can of FIG. 10 which has four wheels.

FIG. 12 is a schematic diagram illustrating an oval waste container.

FIG. 13 is a schematic diagram illustrating an inner can for use in coupling with the cubical waste container of FIG. 12.

FIG. 14A is a schematic diagram illustrating the bottom of the inner can of FIG. 13 which has one wheel and two feet.

FIG. 14B is a schematic diagram illustrating the bottom of the inner can of FIG. 13 which has two wheels and one foot.

FIG. 14C is a schematic diagram illustrating the bottom of the inner can of FIG. 13 which has three wheels.

FIG. 14D is a schematic diagram illustrating the bottom of the inner can of FIG. 13 which has four wheels.

### DETAILED DESCRIPTION OF THE INVENTION

While the present invention may be embodied in many different forms, designs or configurations, for the purpose of promoting an understanding of the principles of the invention, references will be made to the embodiments illustrated in the drawings and specific language will be used to describe the same. It will nevertheless be understood that no limitation or restriction of the scope of the invention is thereby intended. Any alterations and further implementations of the principles of the invention as described herein are contemplated as would normally occur to one skilled in the art to which the invention relates. In the following description, the use of “a”, “an”, or “the” can refer to the plural. All examples given are for clarification only, and are not intended to limit the scope of the invention.

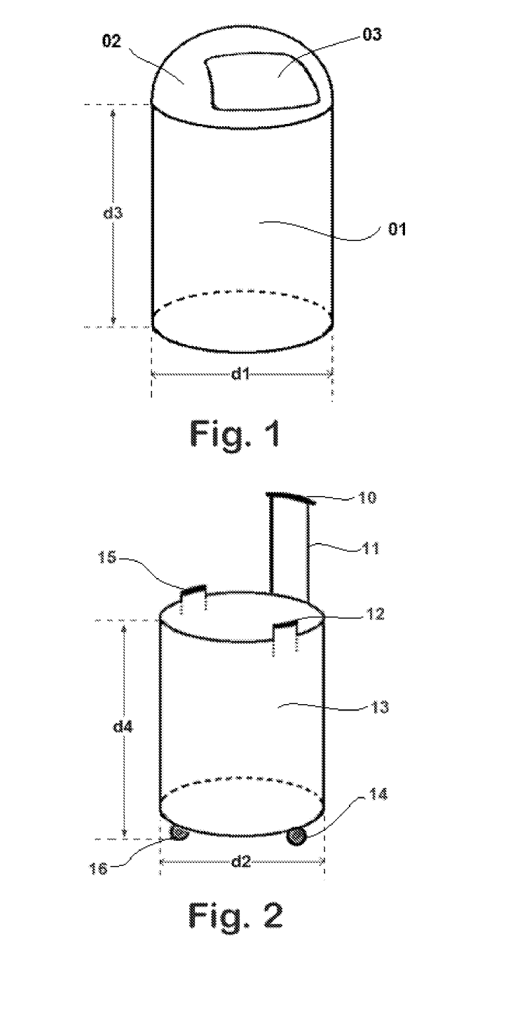

Referring to FIG. 1 which illustrates a typical household kitchen waste container according to the prior art. The container has a cylindrical body 01, a cover 02 and an elastic swingable window 03 from which the trash can be thrown in.

The first preferred embodiment according to the present invention includes an inner can, as illustrated in FIG. 2, which can be adapted to the household kitchen trash can of FIG. 1. The exterior shape is designed according to the shape and measurement of trash can's inner space. The inner can's exterior shape is substantially identical to the trash can's inner shape. However, the inner can's exterior measurement (d2, d4 of FIG. 2) is slightly operably smaller than the trash can's inner measurement (d1, d3 of FIG. 1) such that the inner can be placed in and removed from the trash can easily.

The inner can has a cylindrical body 13 and two extensible handles 12 and 15 which are used for the user to pull the inner can out from the trash can. It has at least one wheel 14/16 at its bottom and an extensible handle 10 for the user to pull the loaded inner can instead of carrying it.

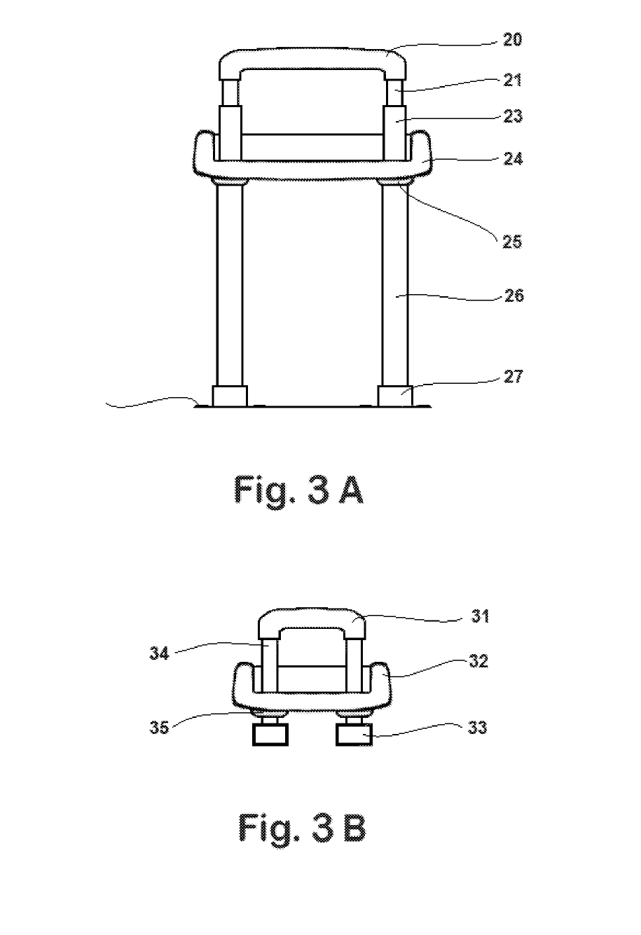

FIG. 3A is a schematic diagram illustrating a typical structure for the extensible handle for the user to pull and move the loaded inner can. The extensible handle includes a holding member 20, two identical metal arms 21, sleeves or paths 26 in which the arms 21 can be slid in or out, and a housing 24 for keeping the holding member 20 when the arm 21 is slid in the sleeve 26. The sleeves 26 can be embedded in one side of the inner can's body.

FIG. 3B is a schematic diagram illustrating a typical structure for a pair of extensible handles (12, 15 of FIG. 2) for the user to pull out and remove the loaded inner can from the trash can. Each of the extensible handle includes a holding member 31, two identical arms 34, sleeves or paths 33 in which the arms 34 can be slid in or out, and a housing 32 for keeping the holding member 31 when the arm 34 is slid in the sleeve 33. The sleeves 26 can be embedded in one side of the inner can's body.

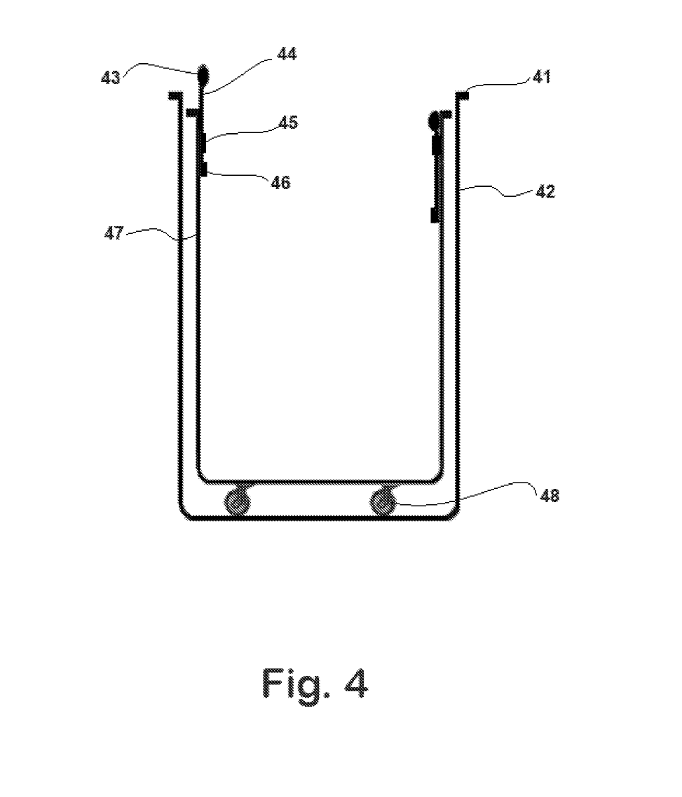

FIG. 4 is a schematic diagram illustrating a sectional view of the inner can placed in the waste container. The exterior wall 47 of the inner can is placed in the inner wall 42 of the trash can. The pull-up handle 43 coupled to the inner can's body can be pushed down such that the holding member 43 is lower than the top edge 41 of the trash can. The wheels 48 are in the space between the inner can's bottom and the trash can's bottom.

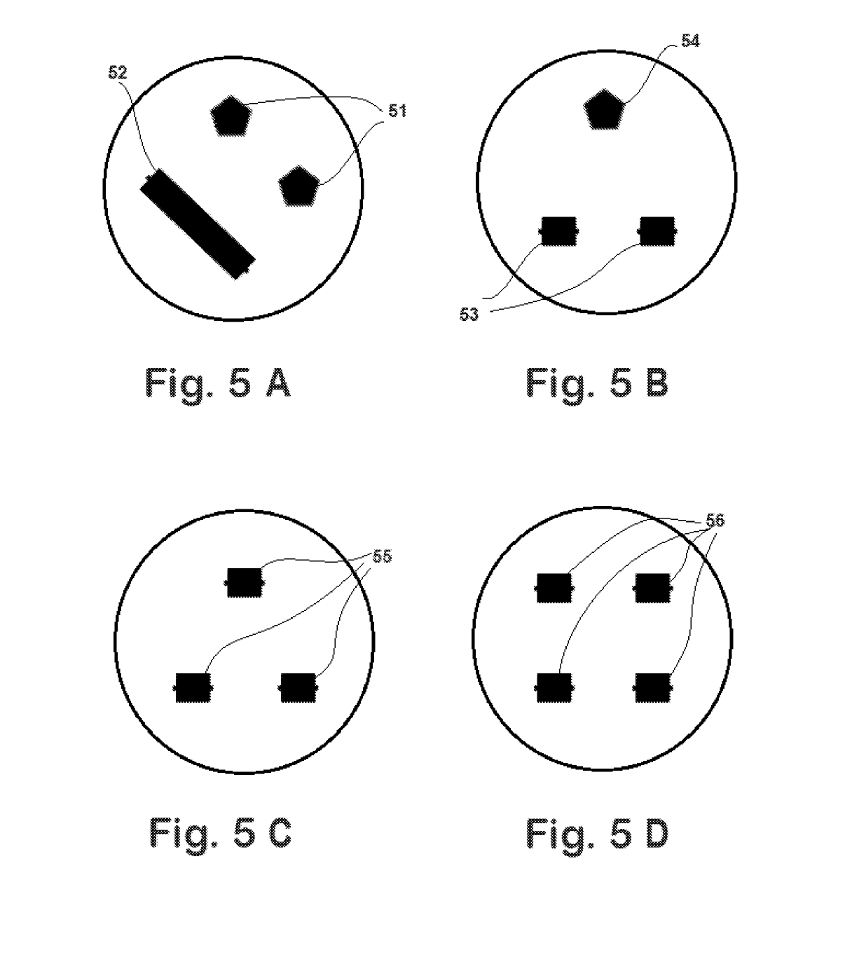

The wheels and supporting foot/feet in the inner can's bottom can be in different arrangement. For example, FIG. 5A illustrates the inner can's bottom with one wheel 52 and two feet 51. FIG. 5B illustrates the inner can's bottom with two wheels 53 and one foot 54. FIG. 5C illustrates the inner can's bottom with three wheels 55. FIG. 5D illustrates the inner can's bottom with four wheels 56.

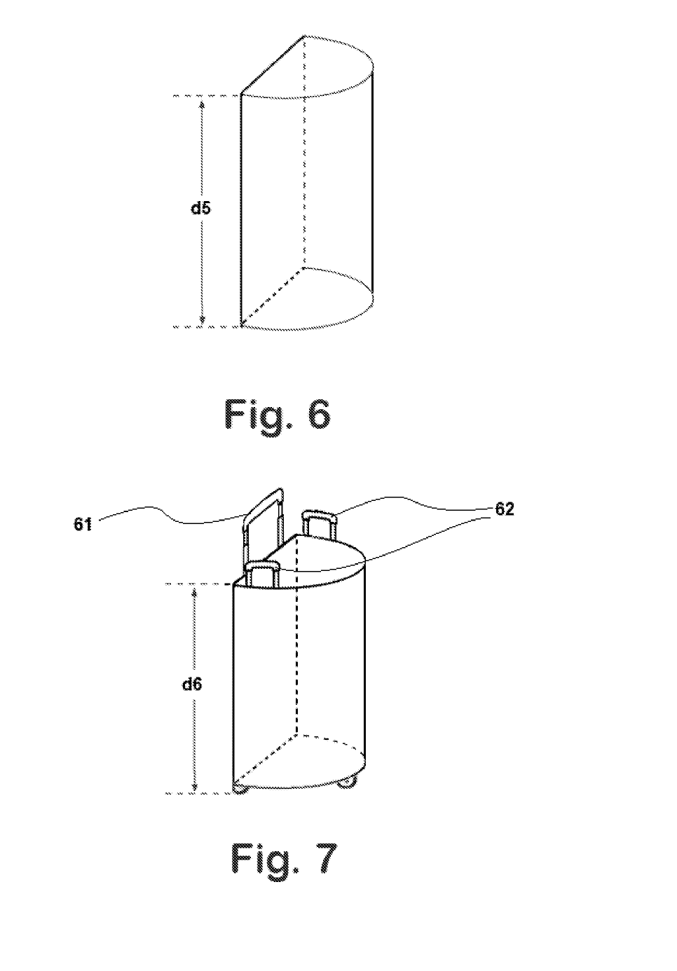

Some waste container is in half-cylindrical shape as illustrated in FIG. 6. The inner can according to the present invention can also be adapted to this type of waste container. FIG. 7 illustrates an inner can for use in coupling with the half-cylindrical waste container according to the second preferred embodiment of this invention.

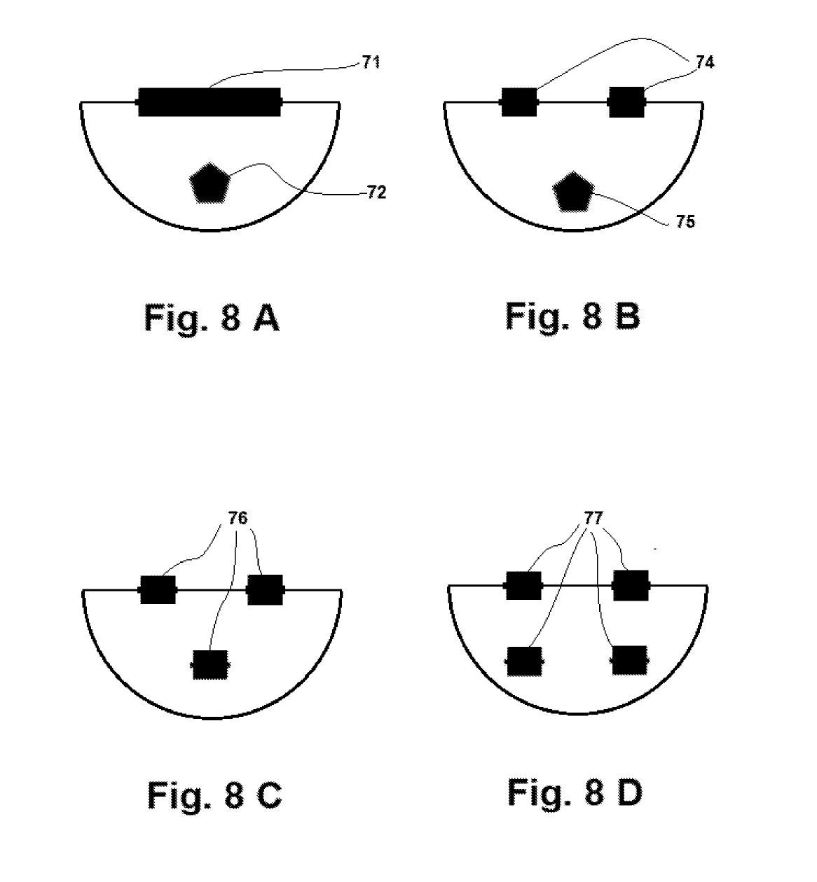

The wheels and supporting foot/feet in the inner can's bottom can be in different arrangement. FIG. 8A illustrates the bottom of the inner can of FIG. 7 which has one wheel 71 and one foot 72. FIG. 8B illustrates the bottom of the inner can of FIG. 7 which has two wheels 74 and one foot 75. FIG. 8C illustrates the bottom of the inner can of FIG. 7 which has three wheels 76. FIG. 8D illustrates the bottom of the inner can of FIG. 7 which has four wheels 77.

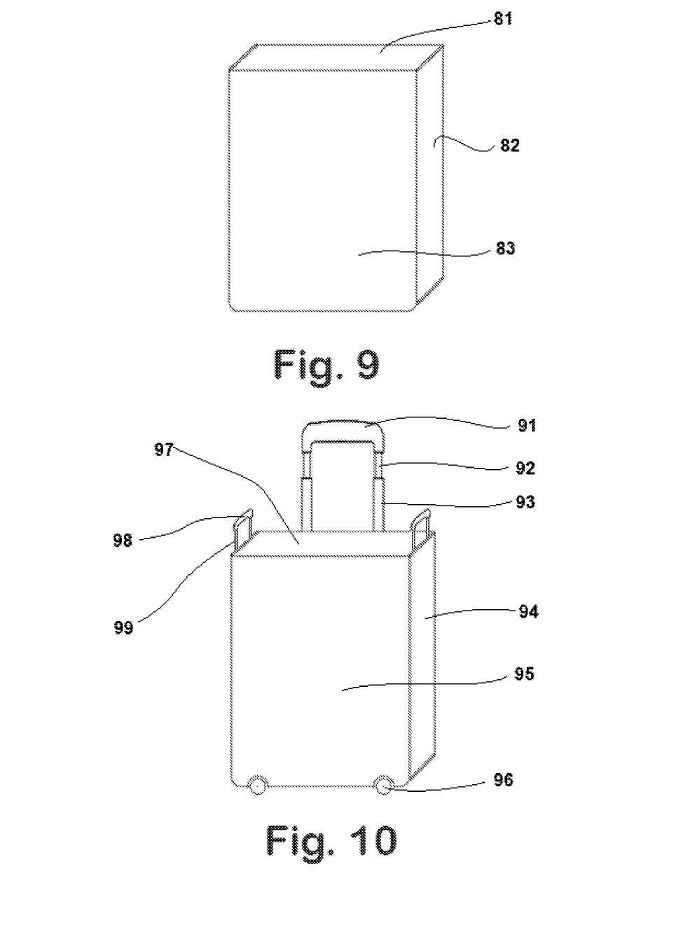

Some waste container is in cubical shape as illustrated in FIG. 9. The inner can according to the present invention can also be adapted to this type of waste container. FIG. 10 illustrates an inner can for use in coupling with the cubical waste container according to the third preferred embodiment of this invention.

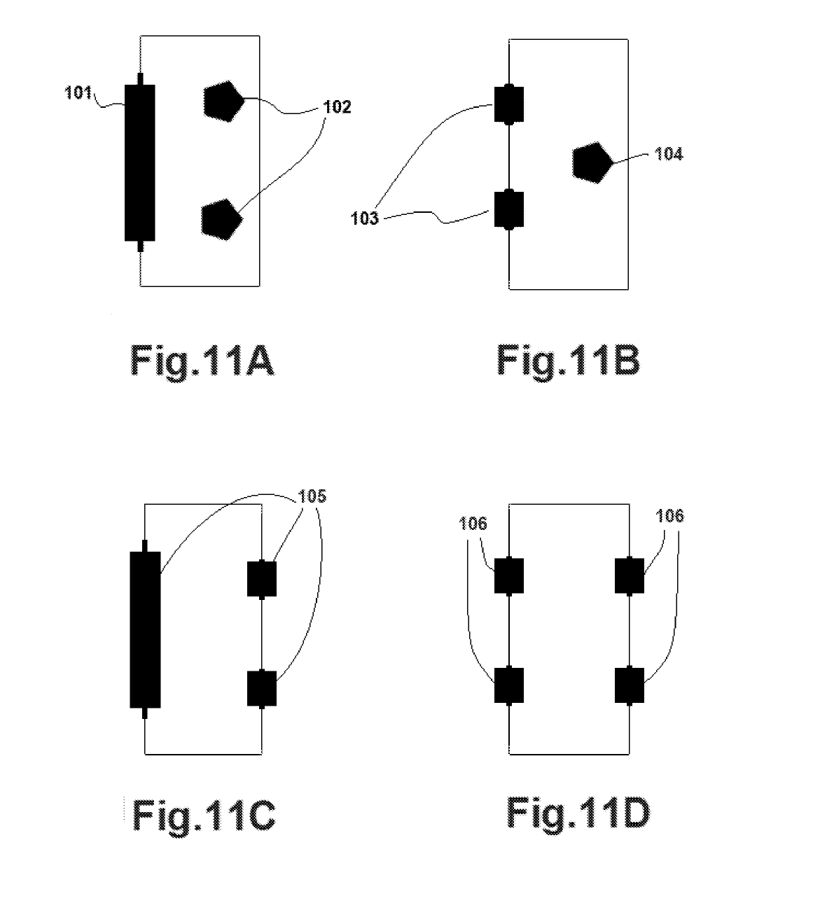

The wheels and supporting foot/feet in the inner can's bottom can be in different arrangement. For example, FIG. 11A illustrates the bottom of the inner can of FIG. 10 which has one wheel 102 and two feet 102. FIG. 11B illustrates the bottom of the inner can of FIG. 10 which has two wheels 103 and one foot 104. FIG. 11C illustrates the bottom of the inner can of FIG. 10 which has three wheels 105. FIG. 11D illustrates the bottom of the inner can of FIG. 10 which has four wheels 106.

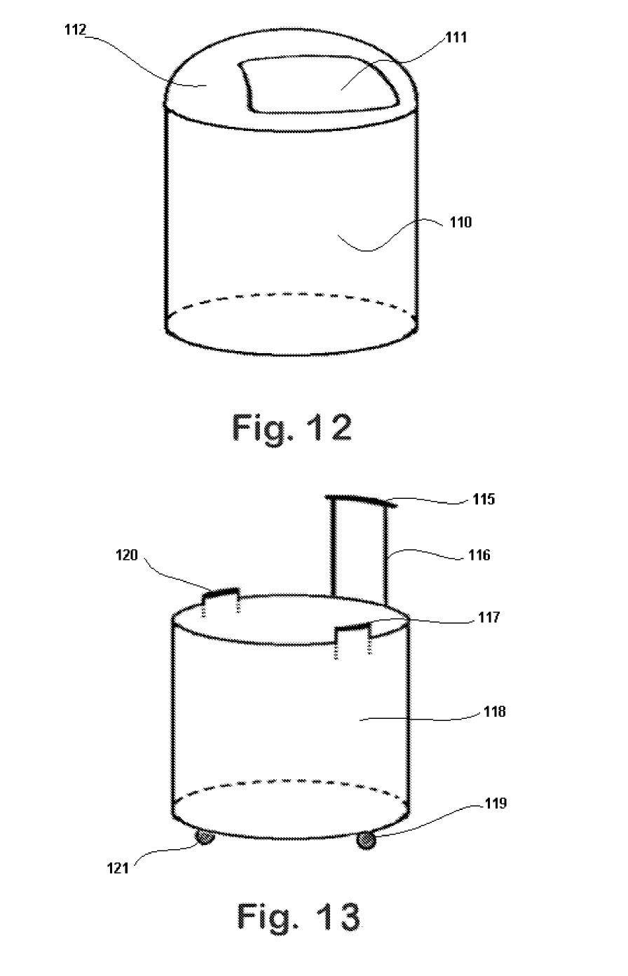

Some waste container is in oval shape as illustrated in FIG. 12. The inner can according to the present invention can also be adapted to this type of waste container. FIG. 13 illustrates an inner can for use in coupling with the oval waste container according to the fourth preferred embodiment of this invention.

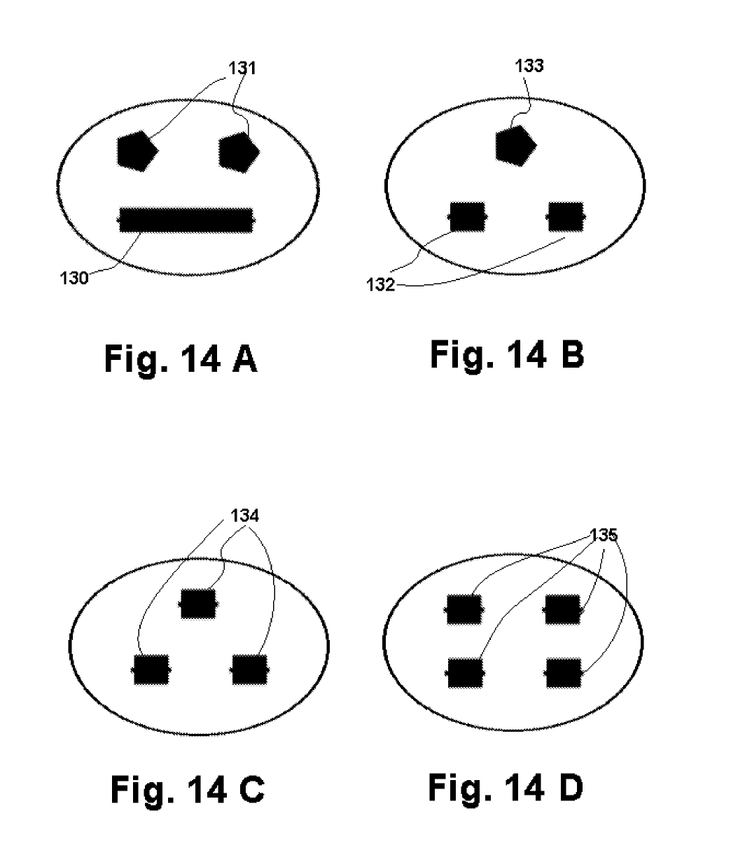

The wheels and supporting foot/feet in the inner can's bottom can be in different arrangement. For example, FIG. 14A illustrates the bottom of the inner can of FIG. 13 which has one wheel 130 and two feet 131. FIG. 14B illustrates the bottom of the inner can of FIG. 13 which has two wheels 132 and one foot 133. FIG. 14C illustrates the bottom of the inner can of FIG. 13 which has three wheels 134. FIG. 14D illustrates the bottom of the inner can of FIG. 13 which has four wheels 135.

The wheels used in the bottom of the inner can according to this invention can be in any shape. Preferably, the wheel is 360 degree turnable.

The foot/feet used as supports in the bottom of the inner can according to this invention can be in any shape. The function of such type of foot/feet is to maintain the inner can's bottom paralleled to the bottom of the waste container.

In addition, any prior art hook-or-hole accessories or structures for attaching the garbage plastic bag can be optionally in the adaptor according to this invention. In many embodiments, the adaptor's coupling with a waste container will not affect the use of hook-or-hole on the waste container.

While one or more embodiments of the present invention have been illustrated in detail, the skilled artisan will appreciate that modifications and adoptions to those embodiments may be made without departing from the scope and spirit of the present invention as set forth in the claims to be set forth in the non-provisional application.

1. A trash can adaptor, comprising an inner can with an exterior shape which is substantially identical to said trash can's inner shape, said inner can's exterior measurement is slightly smaller than said trash can's inner measurement such that said inner can be operably placed in and removed from said trash can easily.

2. The trash can adaptor of claim 1, wherein said inner can has two extensible handles which are used for a user to pull said inner can out from said trash can.

3. The trash can adaptor of claim 2, wherein inner can has at least one wheel at its bottom and an extensible handle for the user to pull said inner can instead of carrying it.
